(19) United States
(12) Patent Application Publication
(10) Pub. No.: US 2017/0262201 A1
(43) Pub. Date: Sep. 14, 2017

(54) INFORMATION PROCESSING APPARATUS, INFORMATION PROCESSING SYSTEM AND PROGRAM MEDIUM

(71) Applicant: FUJITSU LIMITED, Kawasaki-shi (JP)

(72) Inventors: Mikio ENDO, Numazu (JP); Hiroyuki KATAYAMA, Numazu (JP); Hideyuki ARAI, Numazu (JP)

(73) Assignee: FUJITSU LIMITED, Kawasaki-shi (JP)

(21) Appl. No.: 15/412,639

(22) Filed: Jan. 23, 2017

(30) Foreign Application Priority Data
Mar. 8, 2016 (JP) 2016-044187

(51) Int. Cl. G06F 3/06

(52) U.S. Cl. CPC G06F 3/0619; G06F 3/0638; G06F 3/065; G06F 3/0683

(57) ABSTRACT

In an information processing system having first and second computers, the first computer updates pieces of data which have a dependency relationship, generates a first hash value from the data updated, transmits it to the second computer, and thereafter, transmits the data updated to the second computer, and the second computer generates, when receiving the first hash value from the first computer, backups of the pieces of data before an update stored in a memory as a replica, starts receiving the data updated from the first computer, and updates the data stored in the memory using the received data. When the first computer goes down while in a communication, the second computer generates a second hash value from the pieces of data stored in the memory, and restores, if the first and the second hash values do not match, the data stored in the memory using the generated backups.

### CROSS-REFERENCE TO RELATED APPLICATION

This application is based upon and claims the benefit of priority of the prior Japanese Patent Application No. 2016-044187, filed on Mar. 8, 2016, the entire contents of which are incorporated herein by reference.

### FIELD

The embodiment discussed herein is related to a replication technology.

### BACKGROUND

There are cases where, in a web application server, in view of business continuity planning (BCP) and disaster recovery (DR), a technology called replication is adopted. Replication is a technology of generating a replica having the same contents as those of data of a master and synchronizing the replica with the master at all times and, when the data of the master is updated, the update is reflected on the replica in real time.

Various types of data (for example, a file, a table, or the like) in the web application server are targets of replication and, some of the various types of data are data a function of which is not realized unless another data having relevance exists. Such a relationship between pieces of data is referred to as a dependency relationship.

FIG. 1 illustrates an example of pieces of data which have a dependency relationship. In FIG. 1, an example in which a mail setting is changed using a setup wizard screen 1000 is illustrated. When a simple mail transfer protocol (SMTP) server name and a port number are input by an administrator or the like, mail settings 1001 to 1003 are generated in accordance with the input. The mail setting 1001 is a mail setting that is transmitted from a function that manages a tenant, the mail setting 1002 is a mail setting that is transmitted from a function that manages a platform, and the mail setting 1003 is a mail setting that is transmitted from a function that calculates a usage charge. Although each of the mail settings 1001 to 1003 includes information indicating substantially the same contents, a mail function does not correctly operate, if even one of the mail settings 1001 to 1003 is lost, because the mail settings 1001 to 1003 have a dependency relationship.

FIG. 2 illustrates another example of pieces of data which have a dependency relationship. In FIG. 2, an example in which the layout of a portal site 2000 is changed is illustrated. Each rectangular diagram in the portal site 2000 represents a user interface component and the arrangement of the user interface components is managed on a web site. As illustrated in FIG. 2, assume that a component “SCHEDULE” has been changed to a component “TASK LIST”, and furthermore, the arrangement of components has been changed. Also, assume that an image that is displayed by a component “IMAGE DISPLAY” has been changed. In this case, data that is to be updated is the web template of the portal site 2000, information used for associating the portal site 2000 and an arrangement part with one another, and an image file. The above-described pieces of data have a dependency relationship, and therefore, when an update of one of the above-described pieces of data has not been performed, the portal site 2000 is not correctly displayed.

With reference to FIG. 3 and FIG. 4, an update of pieces of data which have a dependency relationship will be described. In each of FIG. 3 and FIG. 4, data of a master is managed in a master server and a replica is managed in a replica server. As illustrated in FIG. 3, assume that data A, data B, and data C which have a dependency relationship have been updated in accordance with a request from a client device (pieces of data after the update are data A^{u}, data B^{u}, and data C^{u}). In this case, as illustrated in FIG. 4, the pieces of data are transmitted to a replica server in the order of the data A^{u}, the data B^{u}, and the data C^{u} and, if the master server goes down while the data C^{u} is being transmitted, the replica of the data C^{u} is in an incomplete state. Accordingly, in the replica server, the pieces of data after the update are incomplete, and therefore, a function is not correctly realized.

The above-described problems are not solved by a known technology related to replication, which is disclosed in such as Japanese Laid-open Patent Publication No. 2006-277158 and Japanese Laid-open Patent Publication No. 2004-86769 discuss related art.

In an aspect, it is an object of the present disclosure to provide a technology used not to cause a state in which only some of a plurality of update targets which have a dependency relationship are updated to occur.

### SUMMARY

According to an aspect of the invention, in an information processing system having first and second computers, the first computer updates a plurality of pieces of data which have a dependency relationship, generates a first hash value from the plurality of pieces of data after an update, transmits it to the second computer, and thereafter, transmits the plurality of pieces of data after the update to the second computer, and the second computer generates, when receiving the first hash value from the first computer, backups of a plurality of pieces of data before an update stored in a memory as replicas of the plurality of pieces of data, starts receiving the plurality of pieces of data after the update from the first computer, and updates the plurality of pieces of data stored in the memory using the received plurality of pieces of data. When the first computer goes down while in a communication, the second computer generates a second hash value from the plurality of pieces of data stored in the memory, and restores, if the first and the second hash values do not match, the plurality of pieces of data stored in the memory using the generated backups.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of pieces of data which have a dependency relationship;

FIG. 2 is a diagram illustrating another example of pieces of data which have a dependency relationship;

FIG. 3 is a diagram illustrating an update of pieces of data which have a dependency relationship;

FIG. 4 is a diagram illustrating a failure during an update of pieces of data which have a dependency relationship;

FIG. 5 is a diagram illustrating restoration by backup;

FIG. 6 is a diagram illustrating a rewind function;

FIG. 7 is a diagram illustrating an outline of a system according to an embodiment;

FIG. 8 is a flowchart illustrating a processing flow of processing executed by a master server;

FIG. 9 is a diagram illustrating thread monitoring and a dependency relationship list;

FIG. 10 is a diagram illustrating an example of a dependency relationship list;

FIG. 11 is a flowchart illustrating a processing flow of processing executed by a slave server;

FIG. 12 is a diagram illustrating processing according to the embodiment; and

FIG. 13 is a functional block diagram of a computer device.

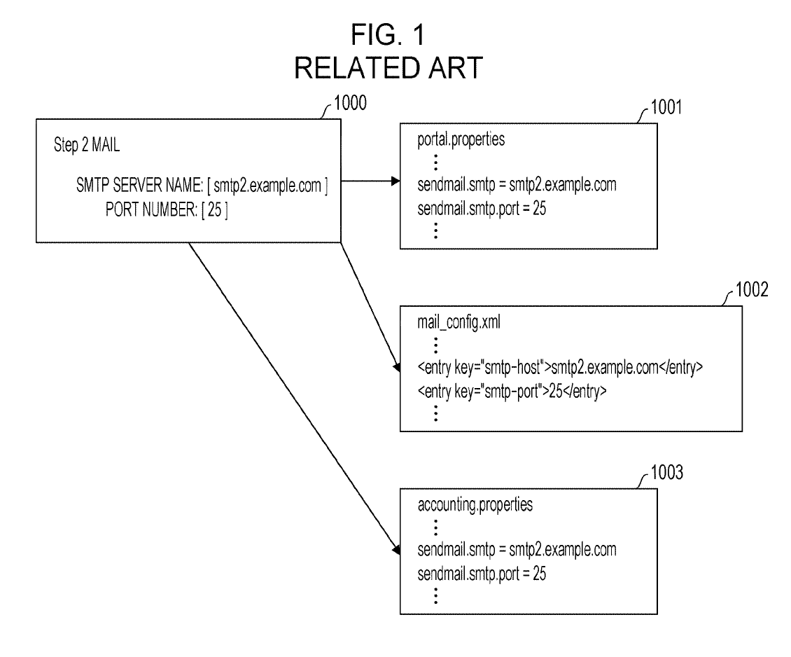

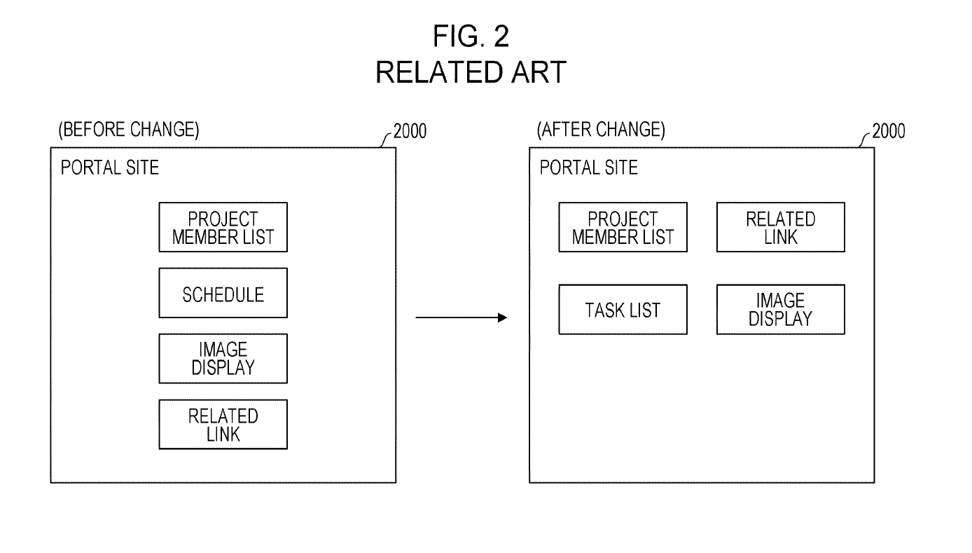

### DESCRIPTION OF EMBODIMENT

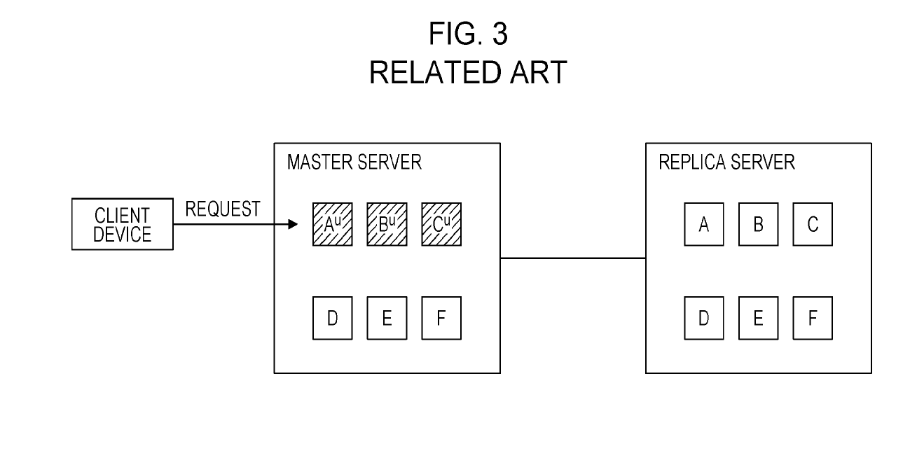

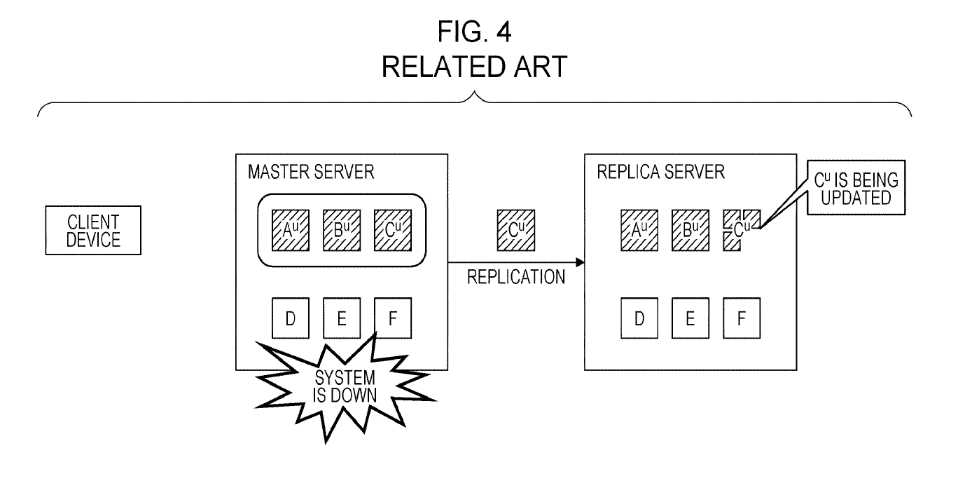

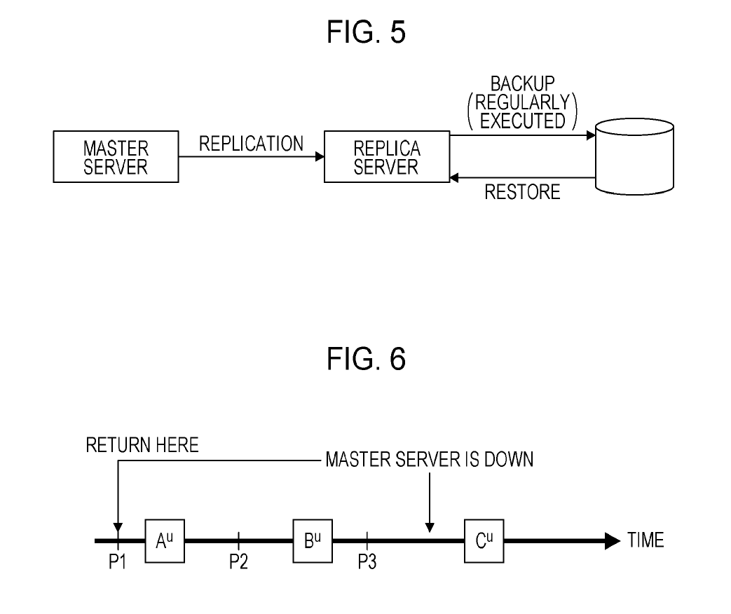

In each of examples of FIG. 3 and FIG. 4, if backups of data A, data B, and data C that are pieces of data before an update are generated in advance, even when an update is not completed, each of the data A, the data B, and the data C may be returned to an original state using the backups. That is, as illustrated in FIG. 5, backups of pieces of data are stored in a storage device (for example, a hard disk drive (HDD) or the like) which a replica server may access in advance. Then, when a master server goes down while the pieces of data are being updated, each of the pieces of data are returned to (that is, restored to) a state before an update using the backups stored in the storage device, and thus, a state in which only some of the pieces of data which have a dependency relationship have been updated does not occur. However, a normal backup is regularly executed but not in real time. Therefore, each of the pieces of data are returned to a state at the time of the previous backup, so that not only the some of the pieces of data which are to be restored but also each of the other ones of the pieces of data is also returned to the previous state.

As another method, returning the state of data to a rewind point using a rewind function may be employed. For example, as illustrated in FIG. 6, assume that a master server goes down after data B^{u} is transmitted and before data C^{u} is transmitted. In this case, the pieces of data are in a state in which only the data C^{u} has not been updated but, if the state of the pieces of data is returned to a state at a rewind point P1 among rewind points P1 to P3, a state in which the data A^{u}, the data B^{u}, and the data C^{u} have not been updated is achieved. However, when a dependency relationship between the pieces of data is not known, to which rewind point the state of the pieces of data is to be returned may not be determined. Note that, although the dependency relationship between the pieces of data may be estimated from the structure of the pieces of data related to an application, there might be cases where a number of patterns of the dependency relationship are estimated, and it is not easy to estimate the dependency relationship from only the structure of the pieces of data.

Therefore, a method in which the dependency relationship between pieces of data is properly estimated to restore the pieces of data, based on the estimated dependency relationship will be described below.

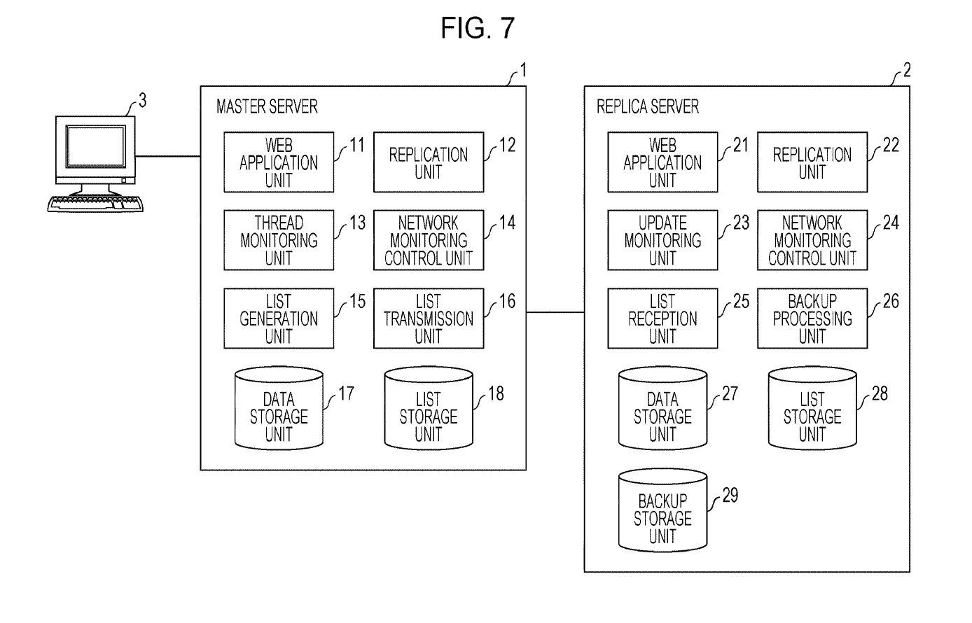

FIG. 7 is a diagram illustrating an outline of a system according to an embodiment. A master server 1 that is a web application server and a replica server 2 that, instead of the master server 1, executes processing when the master server 1 is down are coupled to one another via a local area network (LAN) or the like. A client device 3 is coupled to the master server 1, for example, via the Internet or the like and causes the master server 1 to execute processing as a web application server. Note that, although the client device 3 is also coupled to the replica server 2, a communication between the client device 3 and the replica server 2 is not performed in the description of this embodiment, and therefore, a connection between the client device 3 and the replica server 2 is not illustrated.

The master server 1 includes a web application unit 11, a replication unit 12, a thread monitoring unit 13, a network monitoring control unit 14, a list generation unit 15, a list transmission unit 16, a data storage unit 17, and a list storage unit 18.

The web application unit 11 executes processing by a web application program. The replication unit 12 executes processing of synchronizing data stored in the data storage unit 17 of the master server 1 and data stored in a data storage unit 27 of the replica server 2 with one another at all times. The thread monitoring unit 13 monitors a thread of the web application unit 11. The network monitoring control unit 14 monitors reception of a request from the client device 3. The list generation unit 15 generates a list (which will be hereinafter referred to as a “dependency relationship list”) of pieces of data which have a dependency relationship. The list transmission unit 16 transmits the dependency relationship list generated by the list generation unit 15 to the replica server 2. The data storage unit 17 stores various types of data (for example, a file, a table, or the like) that are processed by the master server 1. The list storage unit 18 stores the dependency relationship list.

The replica server 2 includes a web application unit 21, a replication unit 22, an update monitoring unit 23, a network monitoring control unit 24, a list reception unit 25, a backup processing unit 26, a data storage unit 27, a list storage unit 28, and a backup storage unit 29.

The web application unit 21 executes processing by a web application program. The replication unit 22 executes processing of synchronizing data stored in the data storage unit 17 of the master server 1 and data stored in the data storage unit 27 of the replica server 2 with one another at all times. The update monitoring unit 23 monitors an update of data performed by the replication unit 22. The network monitoring control unit 24 monitors a communication with the master server 1. The list reception unit 25 receives a dependency relationship list from the master server 1. The backup processing unit 26 backs up data, based on the dependency relationship list. The data storage unit 27 stores various types of data (for example, a file, a table, or the like) that are processed by the replica server 2. The list storage unit 28 stores the dependency relationship list. The backup storage unit 29 stores a backup generated by the backup processing unit 26.

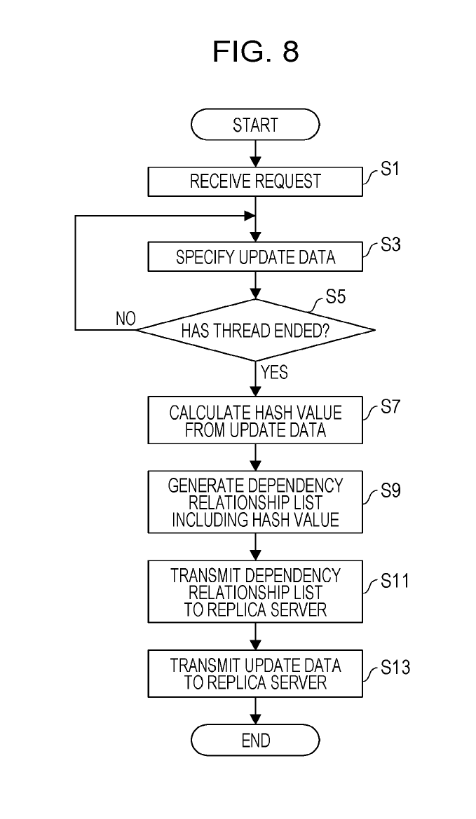

Next, with reference to FIG. 8 to FIG. 12, processing that is executed in the system according to this embodiment will be described. First, with reference to FIG. 8 to FIG. 10, processing that is executed by the master server 1 will be described.

The thread monitoring unit 13 of the master server 1 starts monitoring a thread of the web application unit 11. Note that, when a thread of the web application unit 11 has not been generated, the thread monitoring unit 13 stands by until a thread of the web application unit 11 is generated. Also, the network monitoring control unit 14 starts monitoring reception of a request from the client device 3.

Then, the web application unit 11 receives a request including an order of processing that is performed on data stored in the data storage unit 17 from the client device 3 (Step S1 in FIG. 8). Thus, a thread of the web application unit 11 is generated in Step 51, and therefore, the thread monitoring unit 13 starts monitoring the thread of the web application unit 11. Monitoring of the thread monitoring unit 13 continues until the thread ends.

The thread monitoring unit 13 monitors an update of data stored in the data storage unit 17, which is executed in the thread of the web application unit 11, and specifies data (which will be hereinafter referred to as update data) which has been updated (Step S3). In this embodiment, assuming that pieces of data which have a dependency relationship are processed in the same thread, subsequent processing is executed. Therefore, if the data A, the data B, and the data C are specified by the thread monitoring unit 13 in Step S3, the data A, the data B, and the data C are handled as pieces of data which have a dependency relationship.

The thread monitoring unit 13 determines whether or not the thread of the web application unit 11 has ended (Step S5). If the thread of the web application unit 11 has not ended (a NO route in Step S5), the data update in accordance with the order included in the request continues, and therefore, the process returns to Step S3.

On the other hand, if the thread of the web application unit 11 has ended (a YES route in Step S5), the thread monitoring unit 13 reads out the update data from the data storage unit 17 and outputs the readout update data to the list generation unit 15.

The list generation unit 15 calculates a hash value from each of pieces of update data (Step S7). For example, if the pieces of update data are the data A, the data B, and the data C, a hash value is calculated from the data A, a hash value is calculated from the data B, and a hash value is calculated from the data C.

The list generation unit 15 generates a dependency relationship list including the hash value calculated in Step S7 and identification information of the update data (Step S9) and stores the generated dependency relationship list in the list storage unit 18.

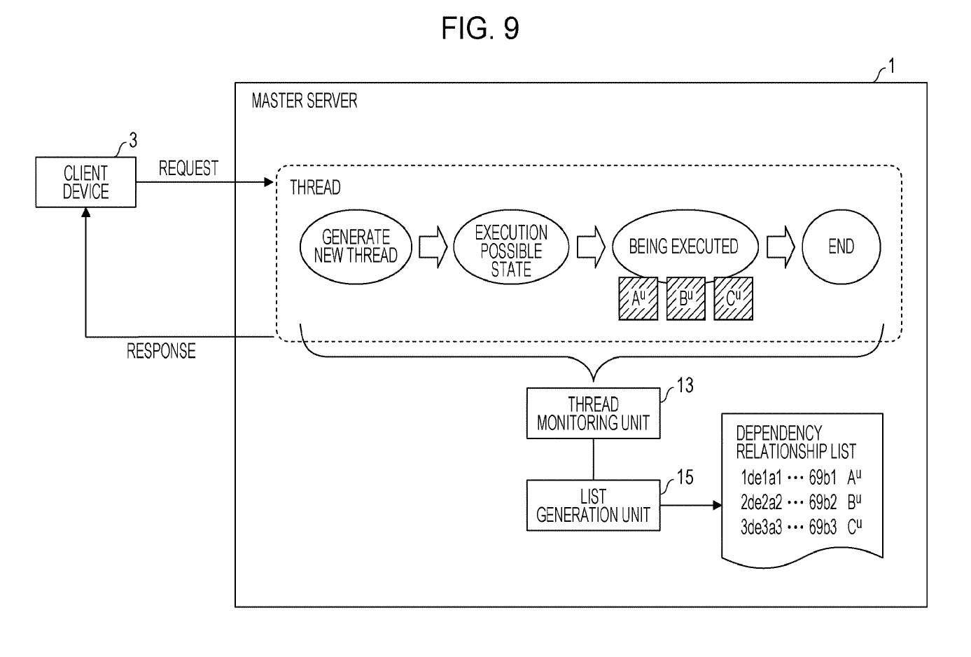

With reference to FIG. 9, thread monitoring and a dependency relationship list will be described. In the master server 1, when the master server 1 receives a request from the client device 3, a thread of the web application unit 11 is generated. The thread monitoring unit 13 transitions, after a thread is generated, to an execution possible state, transitions to a state in which an update is being executed, and then, monitors a life cycle up to an end of the thread. When the thread ends, a response is transmitted to the client device 3. The thread monitoring unit 13 outputs the data (that is, the update data) which has been updated by the thread to the list generation unit 15. Accordingly, the list generation unit 15 generates a dependency relationship list.

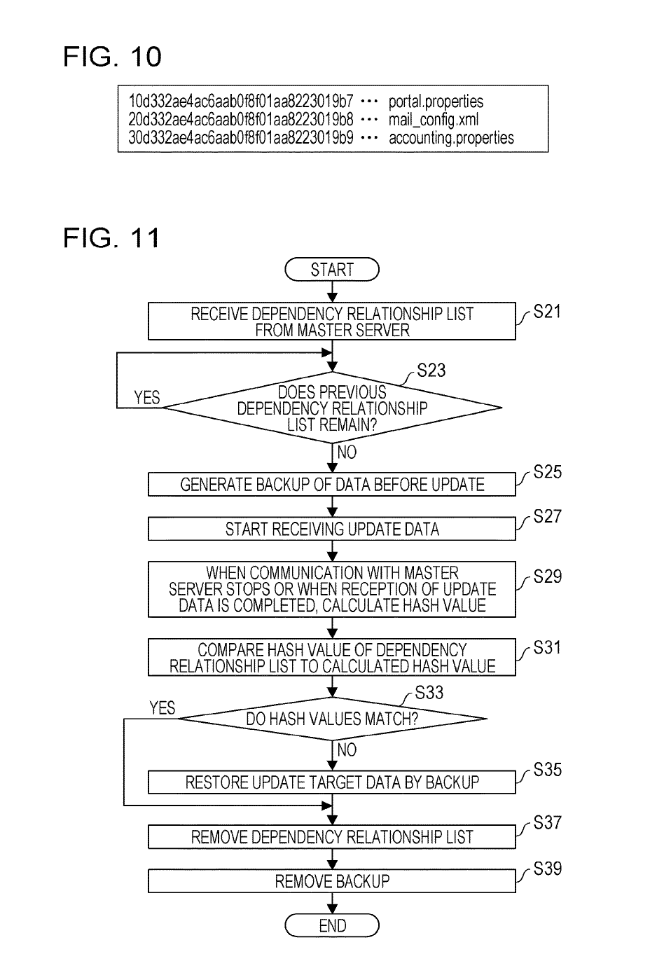

FIG. 10 illustrates an example of a dependency relationship list. In the example of FIG. 10, a dependency relationship list includes a hash value generated from data and identification information (a file name in the example of FIG. 10) of data.

The list transmission unit 16 reads out the dependency relationship list generated in Step S9 from the list storage unit 18 and transmits the readout dependency relationship list to the replica server 2 (Step S11).

Thereafter, the replication unit 12 reads out update data stored in the data storage unit 17 and transmits the readout update data to the replica server 2 (Step S13). That is, replication for the update data is executed. Then, processing ends.

When the above-described processing is executed, the dependency relationship between pieces of data is specified, and therefore, the replica server 2 is enabled to execute restoration based on the specified dependency relationship.

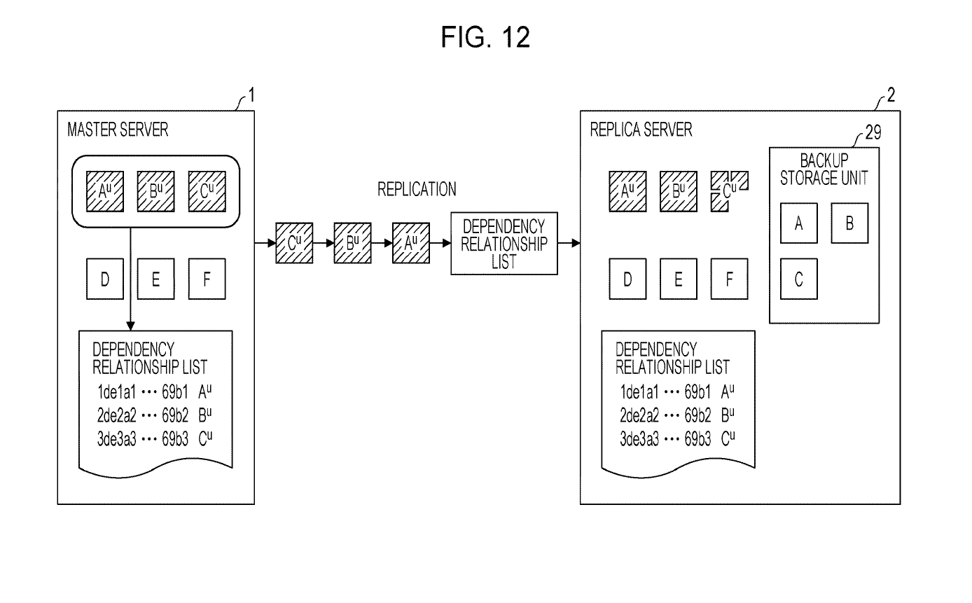

Next, with reference to FIG. 11 and FIG. 12, processing executed by the replica server 2 will be described.

First, the update monitoring unit 23 of the replica server 2 starts monitoring an update of data stored in the data storage unit 27, which is performed by the replication unit 22. Also, the network monitoring control unit 24 starts monitoring reception of the dependency relationship list from the master server 1.

Then, the list reception unit 25 in the replica server 2 receives the dependency relationship list from the master server 1 (Step S21 in FIG. 11) and stores the received dependency relationship list in the list storage unit 28.

Accordingly, the network monitoring control unit 24 determines whether or not some other dependency relationship list (that is, a previous dependency relationship list) than the dependency relationship list received this time remains in the list storage unit 28 (Step S23).

If the previous dependency relationship list remains in the list storage unit 28 (a YES route in Step S23), the previous update has not ended yet, the process returns to Step S23. In this case, the network monitoring control unit 24 of the replica server 2 may be configured to notify the network monitoring control unit 14 of the master server 1 that the previous update has not ended yet and the network monitoring control unit 14 of the master server 1 may be configured to put transmission to the replica server 2 side in a wait state for a predetermined period of time. If the previous dependency relationship list does not remain in the list storage unit 28 (a NO route in Step S23), the network monitoring control unit 24 notifies the backup processing unit 26 that an update will start.

Accordingly, the backup processing unit 26 reads out a dependency relationship list from the list storage unit 28 and specifies data before an update, which corresponds to update data specified by the dependency relationship list, from the data storage unit 27. Then, the backup processing unit 26 generates a backup of the data before the update, which has been specified (Step S25) and stores the generated backup in the backup storage unit 29. For example, if the data A, the data B, and the data C are updated to the data A^{u}, the data B^{u}, and the data C^{u}, in Step S25, the data A, the data B, and the data C are specified from the data storage unit 27. When the generation of backups is completed, the backup processing unit 26 notifies the replication unit 22 that the generation of backups is completed.

Accordingly, the replication unit 22 starts reception of update data from the master server 1 (Step S27) and stores the update data in the data storage unit 27. For example, the data A, the data B, and the data C that are pieces of data before an update are stored in the data storage unit 27 and, if pieces of update data are the data A^{u}, the data B^{u}, and the data C^{u}, the data A, the data B, and the data C are replaced with the data A^{u}, the data B^{u}, and the data C^{u}.

Note that the update data is transmitted in a form of a packet having a predetermined size, and thus, an update for the data A, the data B, and the data C gradually proceeds. Therefore, when the master server 1 goes down before an update for the data A, the data B, and the data C is completed, a state in which only some of pieces of data have been updated occurs.

When an update by the replication unit 22 starts, the update monitoring unit 23 monitors reception of update data. On the other hand, when a communication with the master server 1 stops, the replication unit 22 notifies the update monitoring unit 23 that the communication with the master server 1 has stopped. When the communication with the master server 1 stops or when reception of update data is completed, the update monitoring unit 23 calculates a hash value from update target data stored in the data storage unit 27 (Step S29). For example, in a case where the data A, the data B, and the data C are updated to the data A^{u}, the data B^{u}, and the data C^{u}, when reception of update data is completed, hash values are generated from the data A^{u}, the data B^{u}, and the data C^{u}. In contrast, when reception of update data is not completed and the update is incomplete or when the master server 1 goes down in the middle of an update, hash values are calculated in a state in which only some of the data A, the data B, and the data C have been updated. In this case, the calculated hash values are different from the hash values calculated from the data A^{u}, the data B^{u}, and the data C^{u}.

The update monitoring unit 23 reads out the hash values from the dependency relationship list stored in the list storage unit 28. Then, the update monitoring unit 23 compares the readout hash values and the hash values calculated in Step S29 to one another (Step S31) and determines whether or not the readout hash values and the hash values calculated in Step S29 match (Step S33).

If the readout hash values and the hash values calculated in Step S29 match (a YES route in Step S33), the update of data is completed, and therefore, the process proceeds to Step S37. On the other hand, if the readout hash values and the hash values calculated in Step S29 do not match (a NO route in Step S33), the update monitoring unit 23 reads out a backup of update target data from the backup storage unit 29. Then, the update monitoring unit 23 restores the update target data using the backup (Step S35). The update target data is returned to a state before the update by the processing of Step S35. Thus, a state in which only some of pieces of data have been updated does not occur.

Note that, even when a communication with the master server 1 stops, there may be cases where the update of data is not incomplete. In a communication with the master server 1, a transfer of some other data than update data or the like is also performed, and therefore, there are cases where an update of data has been already completed even while the communication with the master server 1 is being performed. Therefore, as described above, even when a communication with the master server 1 has stopped, whether or not to execute restoration may be properly determined by performing a comparison between hash values.

The update monitoring unit 23 removes the current dependency relationship list from the list storage unit 28 (Step S37). Also, the backup processing unit 26 removes the current backup from the backup storage unit 29 (Step S39). Then, the processing ends.

With reference to FIG. 12, additional description of processing according to this embodiment will be given below. In FIG. 12, pieces of data before an update are the data A, the data B, and the data C and pieces of update data are the data A^{u}, the data B^{u}, and the data C^{u}. As described above, a dependency relationship list generated in the master server 1 is transmitted to the replica server 2. The dependency relationship list includes hash values calculated from the data A^{u}, the data B^{u}, and the data C^{u}, and therefore, when hash values that match the hash values are not calculated in the replica server 2, only some of the data A, the data B, and the data C have been updated. When only some of the pieces of data have been updated, the state of the pieces of data is returned to a state before the update. Thus, a state in which the pieces of data which have a dependency relationship may not realize a function is not caused to occur, so that the replica server 2 in a normal state may take over processing of the master server 1.

Although one embodiment of the present disclosure has been described above, the present disclosure is not limited thereto. For example, there are cases where the functional block configuration of the master server 1 and the replica server 2 described above does not match an actual program module configuration.

Also, the above-described data configuration is merely an example and a different data configuration from the above-described data configuration may be used. Furthermore, also in the above-described processing flows, as long as the same processing result is achieved, the processing order may be changed. Furthermore, the process steps in each of the above-described processing flows may be executed in parallel.

Also, in the above-described examples, a backup and a data update may be alternately performed such that reception of the data A^{u} is started in a stage in which an backup of the data A has ended, reception of the data B^{u} is started in a stage in which an backup of the data B has ended, . . . .

Also, information other than a hash value may be used as information which may uniquely identify data.

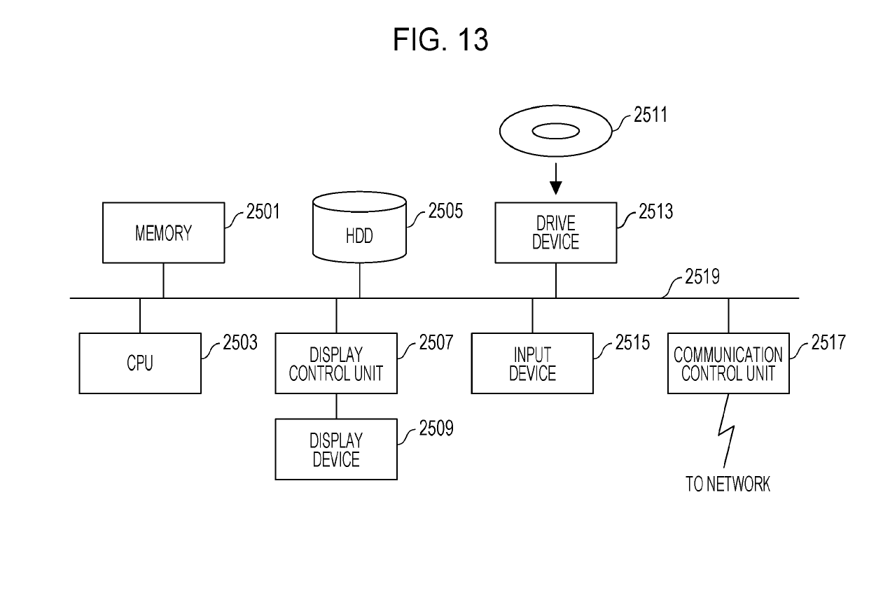

Note that the master server 1 and the replica server 2 that have been described above are computer devices and, as illustrated in FIG. 13, memory 2501, a central processing unit (CPU) 2503, a hard disk drive (HDD) 2505, a display control unit 2507 coupled to a display device 2509, a drive device 2513 for a removable disk 2511, an input device 2515, and a communication control unit 2517 that provides a connection to a network are coupled to one another via a bus 2519. An operating system (OS) and an application program used for performing processing in this embodiment are stored in the HDD 2505 and, when being executed by the CPU 2503, are read out from the HDD 2505 to the memory 2501. The CPU 2503 controls the display control unit 2507, the communication control unit 2517, and the drive device 2513 in accordance with processing contents of the application program and causes each of the display control unit 2507, the communication control unit 2517, and the drive device 2513 to perform a predetermined operation. Also, although data in the middle of processing is mainly stored in the memory 2501, a configuration in which data in the middle of processing is stored in the HDD 2505 may be used. In the above-described embodiment, the application program used for performing the above-described processing is stored in the computer-readable removal disk 2511, is distributed, and is installed in the HDD 2505 from the drive device 2513. There are cases where the application program used for performing the above-described processing is installed in the HDD 2505 via a network, such as the Internet or the like, and the communication control unit 2517. In the computer devices, hardware, such as the CPU 2503, the memory 2501, or the like, the OS, and a program, such as the application program, which have been described above, organically cooperate with one another to realize various functions as described above.

The above-described embodiment of the present disclosure may be summarized as follows.

An information processing method according to a first aspect of this embodiment is executed by a computer. The information processing method includes (A) generating, when, from anther computer that has updated a plurality of data blocks which have a dependency relationship, a first hash value generated from the plurality of data blocks after an update is received, backups of the plurality of data blocks before the update which are stored in a data storage unit, (B) starting reception of the plurality of data blocks after the update from the another computer and updating the plurality of data blocks stored in the data storage unit using in the received data blocks, (C) generating, when the another computer goes down while a communication with the another computer is being performed, a second hash value from the plurality of data blocks stored in the data storage unit, and (D) restoring, if the first hash value and the second hash value do not match, the plurality of data blocks stored in the data storage unit using the generated backups.

Thus, when the another computer goes down even when the update of the plurality of data blocks is not completed, restoration is performed in the plurality of data blocks before the update, which have been backed up, and therefore, a state where only some of the plurality of data blocks have been updated is not caused to occur.

Also, the information processing method may further includes (E) receiving information used for specifying the plurality of data blocks from data blocks managed by the computer from the another computer. Thus, the computer may specify the plurality of data blocks which have a dependency relationship.

An information processing system according to a second aspect of this embodiment includes (F) a first information processing unit and (G) a second information processing unit. The first information processing unit includes (f1) an update unit configured to update a plurality of data blocks which have a dependency relationship, (f2) a generation unit configured to generate a first hash value from the plurality of data blocks after an update, (f3) a first transmission unit configured to transmit the first hash value to the second information processing unit, and (f4) a second transmission unit configured to transmit, after the first hash value is transmitted to the second information processing unit, the plurality of data blocks after the update to the second information processing unit. The second information processing unit includes (g1) a generation unit configured to generate, when the second information processing unit receives the first hash value from the first information processing unit, backups of the plurality of data blocks before an update which are stored in the data storage unit, (g2) an update unit configured to start receiving the plurality of data blocks after the update from the first information processing unit and update the plurality of data blocks stored in the data storage unit using the received data blocks, and (g3) a restoration unit configured to generate, when the first information processing unit goes down while a communication with the first information processing unit is being performed, a second hash value from the plurality of data blocks stored in the data storage unit and restore, if the first hash value and the second hash value do not match, the plurality of data blocks stored in the data storage unit using the generated backups.

Note that a program that causes a computer to execute processing in accordance with the above-described method may be created, and the program is stored in a computer-readable storage medium or storage device, such as, for example, a flexible disk, CD-ROM, a magneto-optical disk, semiconductor memory, a hard disk, or the like. Note that an intermediate processing result is temporarily held in a storage device, such as main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable and non-transitory storage medium having stored a program that causes a computer to execute a process, the process comprising:
generating, when, from another computer that performs an update of a plurality of pieces of data which have a dependency relationship, a first hash value generated from the plurality of pieces of data after the update is received, backups of a plurality of pieces of data before the update which are stored in a data storage unit as replicas of the plurality of pieces of data;
starting receiving the plurality of pieces of data after the update from the another computer and updating the plurality of pieces of data which are stored in the data storage unit using the received pieces of data;
generating, when the another computer goes down while a communication with the another computer is being performed, a second hash value from the plurality of pieces of data which are stored in the data storage unit; and
restoring, if the first hash value and the second hash value do not match, the plurality of pieces of data which are stored in the data storage unit using the generated backups.

2. The storage medium according to claim 1, the process further comprising:
receiving, from the another computer, information used for specifying the plurality of pieces of data from among pieces of data managed by the computer.

3. An information processing apparatus comprising:
a memory; and
a processor coupled to the memory and configured to execute a process, the process comprising;
generating, when, from another information processing unit that performs an update of a plurality of pieces of data which have a dependency relationship, a first hash value generated from the plurality of pieces of data after the update is received, backups of the plurality of pieces of data before the update which are stored in a data storage unit as replicas of the plurality of pieces of data,
starting, after the backups of the plurality of pieces of data are generated, receiving the plurality of pieces of data after the update from the another information processing unit,
updating the plurality of pieces of data which are stored in the data storage unit using the received pieces of data,
generating, when the another information processing unit goes down while a communication with the another information processing unit is being performed, a second hash value from the plurality of pieces of data which are stored in the data storage unit and
restoring, if the first hash value and the second hash value do not match, the plurality of pieces of data which are stored in the data storage unit using the generated backups.

4. An information processing system, comprising:
a first information processing unit; and
a second information processing unit,
wherein the first information processing unit includes;
a first memory, and
a first processor coupled to the first memory and executes a first process, the first process comprising;
updating a plurality of pieces of data which have a dependency relationship,
generating a first hash value from the plurality of pieces of data after an update,
transmitting the first hash value to the second information processing unit, and
transmitting, after the first hash value is transmitted to the second information processing unit, the plurality of pieces of data after the update to the second information processing unit, and
the second information processing unit includes;
a second memory, and
a second processor coupled to the second memory and executes a second process, the second process comprising;
generating, when the second information processing unit receives the first hash value from the first information processing unit, backups of the plurality of pieces of data before an update which are stored in a data storage unit as replicas of the plurality of pieces of data,
starting receiving the plurality of pieces of data after the update from the first information processing unit and updating the plurality of pieces of data which are stored in the data storage unit using the received pieces of data, and
generating, when the first information processing unit goes down while a communication with the first information processing unit is being performed, a second hash value from the plurality of pieces of data which are stored in the data storage unit, and
restoring, if the first hash value and the second hash value do not match, the plurality of pieces of data which are stored in the data storage unit using the generated backups.
